(19) United States
(12) Patent Application Publication
(10) Pub. No.: US 2025/0315768 A1
(43) Pub. Date: Oct. 9, 2025

(54) SYSTEMS AND METHODS FOR KEY PERFORMANCE INDEX PREDICTION AND IMPROVEMENT THROUGH FEATURE ANALYSIS

(71) Applicant: Verint Americas Inc., Alpharetta, GA (US)

(72) Inventors: Ian BEAVER, Chino Valley, AZ (US); Cynthia FREEMAN, Green Valley, AZ (US); Jose BENKI, Ann Arbor, MI (US)

(21) Appl. No.: 18/626,807

(22) Filed: Apr. 4, 2024

(51) Int. Cl. G06Q 10/0639

(52) U.S. Cl. CPC G06Q 10/06393

(57) ABSTRACT

A method for providing a predicted key performance indicator (KPI) value includes receiving a KPI metric and a target value for the KPI metric; receiving customer-agent interaction data; implementing a model corresponding to the KPI metric; predicting, with the model, the value for the KPI metric based on features that the model identifies and measures from the customer-agent interaction data; determining one or more features having a potential for improvement based on measured values of the features determined by the model; determining that improvement in a measured value of the one or more features maintains or increases the value of the KPI metric; and outputting a first indication of whether the value predicted for the KPI metric meets the target value and a second indication of the one or more features that maintains or increases the value of the KPI metric when the one or more features are improved.

### INTRODUCTION

### Technical Field

The present disclosure relates to techniques for predicting a key performance indicator (KPI) value and identifying features for improving the KPI value.

### BACKGROUND

Customer support services are an obligatory aspect of providing customers services or goods. Customer support services provide a means for a consumer of a service or a good to correspond with a company providing the service or good. Consumers contact customer support services for a wide range of reasons. For example, consumers contact customer support service to make a change to the service, address an issue with the service or good, provide feedback to a company, seek information about a service or good, and many other reasons.

Customer support services typically consist of human-operated contact centers that correspond with customers via voice call, video call, email, or chat. In addition to recording a conversational interaction (also referred to as a session) between a representative of the customer support service and the consumer, other metrics may be manually recorded by the representative, such as summarizing the interaction. For example, the representative, post-conversational interaction, may write up a brief summary of the interaction and submit it with the record of the interaction.

Companies providing services and goods and customer support service operators are increasingly interested in improving customer-agent interactions. To improve customer-agent interactions, companies currently rely on surveys generated by customers following the customer-agent interaction. The surveys can inform supervisors as to customer-based KPI metrics.

### SUMMARY

One aspect provides a method for providing a predicted key performance indicator (KPI) value, comprising: receiving a KPI metric and a target value for the KPI metric; receiving customer-agent interaction data; implementing a model corresponding to the KPI metric from a plurality of models, wherein the model is trained to predict a value for the KPI metric; predicting, with the model, the value for the KPI metric based on a plurality of features that the model identifies and measures from the customer-agent interaction data; determining, from the plurality of features, one or more features having a potential for improvement based on measured values of the plurality of features determined by the model; determining that improvement in a measured value of the one or more features maintains or increases the value of the KPI metric; and outputting a first indication of whether the value predicted for the KPI metric meets the target value and a second indication of the one or more features that maintains or increases the value of the KPI metric when the one or more features are improved.

Another aspect provides, an apparatus configured for providing a predicted key performance indicator (KPI) value, comprising: one or more memories comprising processor-executable instructions; and one or more processors configured to execute the processor-executable instructions and cause the apparatus to: receive a KPI metric and a target value for the KPI metric; receive customer-agent interaction data; implement a model corresponding to the KPI metric from a plurality of models, wherein the model is trained to predict a value for the KPI metric; predict, with the model, the value for the KPI metric based on a plurality of features that the model identifies and measures from the customer-agent interaction data; determine, from the plurality of features, one or more features having a potential for improvement based on measured values of the plurality of features determined by the model; determine that improvement in a measured value of the one or more features maintains or increases the value of the KPI metric; and output a first indication of whether the value predicted for the KPI metric meets the target value and a second indication of the one or more features that maintains or increases the value of the KPI metric when the one or more features are improved.

Other aspects provide, a computer program product for providing a predicted key performance indicator (KPI) value, the computer program product comprising instructions, which when executed by a computer, cause the computer to carry out steps comprising: receiving a KPI metric and a target value for the KPI metric; receiving customer-agent interaction data; implementing a model corresponding to the KPI metric from a plurality of models, wherein the model is trained to predict a value for the KPI metric; predicting, with the model, the value for the KPI metric based on a plurality of features that the model identifies and measures from the customer-agent interaction data; determining, from the plurality of features, one or more features having a potential for improvement based on measured values of the plurality of features determined by the model; determining that improvement in a measured value of the one or more features maintains or increases the value of the KPI metric; and outputting a first indication of whether the value predicted for the KPI metric meets the target value and a second indication of the one or more features that maintains or increases the value of the KPI metric when the one or more features are improved.

These and additional features provided by the embodiments described herein will be more fully understood in view of the following detailed description, in conjunction with the drawings.

### DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals.

FIG. 1 schematically depicts an illustrative block diagram of a KPI prediction process.

FIG. 2 schematically depicts an illustrative block diagram of a KPI improvement process.

FIG. 3 schematically depicts an illustrative block diagram for creating a classifier model for the KPI prediction process.

FIG. 4 depicts an illustrative diagram of a process for determining features with potential for improvement such that when improved increase the value predicted for the KPI.

FIG. 5 depicts an illustrative flowchart for an example method for predicting a KPI value and identifying features for improving the KPI value.

FIG. 6 schematically depicts an example apparatus for implementing the KPI prediction process.

### DETAILED DESCRIPTION

Embodiments of the present disclosure are directed to techniques for predicting a KPI from a customer-agent interaction, such as from a conversation between a customer and an agent at a contact center. It should be understood that the term “agent” as discussed herein refers to either human agents or computer-driven bots, such as chatbots, unless specifically stated otherwise. The techniques described herein may be utilized on a variety of conversational interactions. For example, conversational interactions may arise from any type of interaction between two or more entities. The types of customer-agent interactions may include human-to-human interactions, human-to-chatbot interactions, or even chatbot-to-chatbot interactions. As used herein, chatbot refers to artificial intelligence-based engines configured to simulate human conversation through text, video, and/or voice. Chatbots may also be referred to herein as intelligent virtual agents (IVA). IVAs are chatbots that can engage with a human customer or another chatbot using understandable human speech. IVAs may be trained and refined based on interactions, but do not need to be specifically programmed to handle certain types of interactions. Instead, IVAs implement a combination of natural language processing (NLP), natural language understanding (NLU), machine learning, and generative and conversational artificial intelligence (AI) to recognize human speech, understand the intent behind it, and respond in a way that mimics human conversation. Through interactions, IVAs can increase their vocabulary, learn nuances of speech, such as the use of slang terms or acronyms, and adapt based on feedback from other entities they are interacting with and through directed training operations, such as supervised learning. The means in which the interactions may occur include, but are not limited to voice calls, video calls, emails, instant messages, and chats.

Mechanisms for recording conversational interactions exist. For example, a video or voice call may be recorded into a media file. In near real-time or at a later time, the media file can be transcribed into a text-based file converting at least audio aspects of the media into readable text. Text based conversational interactions can be recorded and stored as a text-based data file.

Companies offering services or goods to consumers or customer support services desire to utilize the recorded content from conversational interactions for a variety of purposes. For example, evaluation of the customer-agent interactions can provide insights regarding a customer's satisfaction or dissatisfaction through methods and apparatuses described herein. Currently, KPIs such as a customer satisfaction score are only obtainable through post interaction surveys, which historically have low compliance rates and are generally limited in scope.

Since post interaction surveys are sparse and lack dense (e.g., detailed and numerous) insights for use in evaluating key performance metrics, the present disclosure provides systems, methods, and apparatuses for predicting KPIs from customer-agent interactions. As discussed in more detail herein, the KPI prediction and improvement processes enable the prediction of a value for a KPI metric, irrespective of the presence of a post interaction survey, and can further provide suggested agent-controllable features of a customer-agent interaction that can be improved to maintain or improve a KPI metric. The solutions provided in the present disclosure reduce or eliminate the need for post interaction surveys by providing technical solutions to identifying and measuring features present in customer-agent interactions to predict a KPI metric. KPI metrics include, but are not limited to, customer satisfaction scores (CSAT), customer churn rate (Churn), net promoter score (NPS), and the like. CSAT is a metric that indicates how satisfied customers are with a company's products or services. Churn is the percentage of customers who stop doing business with an organization over a period of time. NPS is a metric that quantifies customer loyalty by looking at their likelihood of recommending a given business.

Example features of a customer-agent interaction during a call, for example, include past average CSAT, Churn, NPS of an agent over a past period of time, the time an agent spends talking during the call with a customer, the time a customer spends talking during the call, the number of interruptions by the agent of the customer in the call, number of interruptions by the customer of the agent, time between an agent's hire date and the call date, call duration, number of holds in the call, the time of mutual silence in the call, number of words spoken by the agent, number of words spoken by the customer, agent speaking rate in word per minute, customer speaking rate in words per minute, number and duration of agent pauses, number and duration of customer pauses, number of conversational turns, the screen module used in the call, knowledge management (KM) searches conducted by the agent, customer relationship management (CRM) access patterns by the agent, survey variables and/or any other features that can be extracted from the customer-agent interaction.

A company, such as a contact center operator, may desire to maintain or improve one or more KPI metrics, but without a statistically significant number of post interaction surveys, the company is unable to effectively determine a value for the one or more KPI metrics and more significantly understand the features of the contact center operation, such as features of the customer-agent interaction that drive the KPI metric. The present disclosure solves this problem by training models, such as a classifier model, gradient boosting classifier, random forest classifier, or other machine learning-based classifiers to analyze features of a customer-agent interaction and predict a value for the desired KPI metric.

The technical solutions described herein utilize data from multiple sources, for example, speech analytics (SA), KM, CRM, and the like along with defined features of a customer-agent interaction to train a classifier model to predict a KPI metric. The technical solutions further provide a process for identifying features of the customer-agent interaction that have a potential for improvement and providing a recommendation as to which features and the amount each of the features need to be improved to meet a target value for the KPI metric. That is, the technical solutions not only provide a prediction of KPI, but also give insight to the user on how they can improve specific, targeted areas of their contact center to meet their KPI goals.

The technical solutions for predicting a KPI metric from customer-agent interaction data provide the technical benefit of reducing or eliminating reliance on post interaction surveys and analysis thereof and improving how a company, such as a contact center operator, can maintain and improve KPI metrics that are relevant to their business.

### Aspects Related to Predicting a KPI Metric

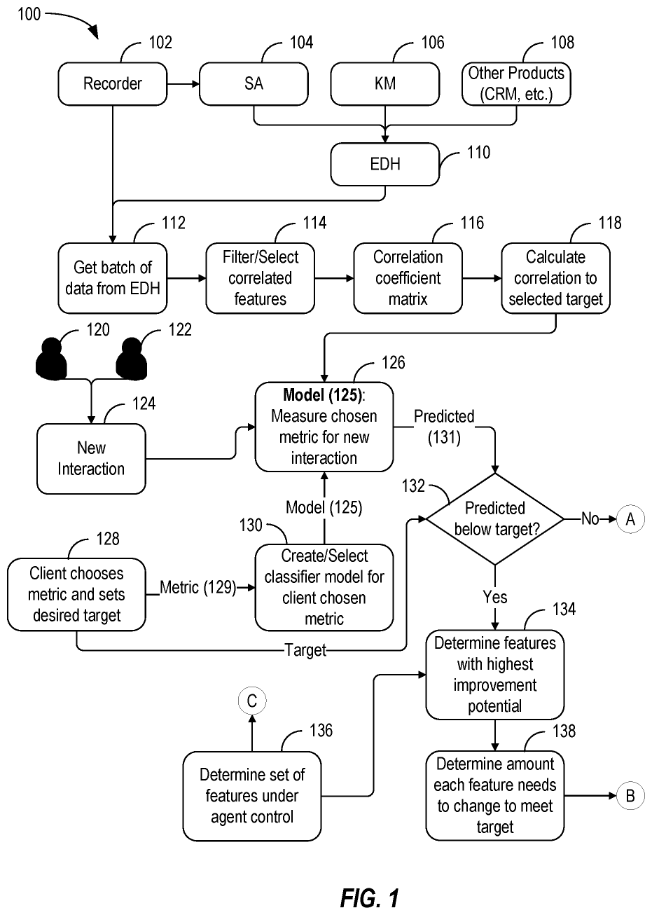

FIG. 1 depicts an illustrative block diagram 100 of a KPI prediction process for predicting a client chosen KPI metric. As will be described in more detail below, the processes described herein utilize historical data to train a classifier model to predict a specified KPI metric. The historical data may be provided from various sources such as transcriptions of a customer-agent interaction via a recorder 102, speech analytics (SA 104) via the recorder 102, KM 106, CRM 108, and the like that can be obtained from the engagement data hub (EDH 110). At step 112, a batch of the aforementioned data including customer-agent interaction data is retrieved and/or received by an apparatus having one or more memories with process-executable instructions, and one or more processors configured to execute the process-executable instructions. The process-executable instructions provide instructions to the one or more processors to carry out the processes and operations described herein.

Steps 112-118 are directed to the sub-processes for determining a fixed set of features to query from the EDH 110, which are subsequently used to train the classifier model. At step 114, the data is filtered so that correlated features can be selected. For example, the most relevant features to a KPI metric are determined by calculating the correlation between the feature and the target KPI metric. The features that are not as correlated, for example, as determined based on a threshold, are filtered out from the plurality of features that are used to train the classifier. At step 116, a correlation coefficient matrix may be generated to indicate a strength of relationship between features with the predefined threshold for filtering applied. At step 118, the correlation between the target KPI metric and each feature is calculated, whereby the lower features, that is, those not having a correlation that meets the predefined threshold, are filtered out.

The data obtained from the EDH 110 and the selected features are used to train one or more classifier models. A separate classifier model may be trained for each KPI metric. Accordingly, depending on the KPI metric a client chooses, a corresponding classifier model that is trained to predict a value for the chosen KPI metric is selected and implemented.

At step 124, new customer-agent interaction data is generated. For example, a customer 120 may correspond with an agent 122 at a contact center where a recorder 102 captures the interaction and related information specific to that customer-agent interaction. For example, related information may include actions the agent employs during the interaction, such as querying a CRM, searching a KM, application modules on the agent's computer utilized including time spent and actions taken in each application module. This information is compiled in a database with timestamps and a session identifier unique to the specific interaction to generate the customer-agent interaction data for the interaction.

The customer-agent interaction data is provided to the classifier model 125 employed at step 126. The classifier model 125 employed at step 126 is determined, for example, based on a client's input of a KPI metric at step 128. Also at step 128, the client sets a target value (e.g., desired target) for the specified KPI metric. At step 130, in response to the KPI metric selected by the client, the corresponding classifier model is either created, if one does not already exist, or is selected from a plurality of classifier models. The selected classifier model 125 is invoked at step 126 to generate a predicted value for the KPI metric specified by the client.

The classifier model 125 predicts a value for the KPI metric based on a plurality of features that the classifier model 125 identifies and measures from the customer-agent interaction data. Additionally, the classifier model 125 generates a score for each feature associated with the KPI metric. Each feature score corresponds to an agent's performance with respect to the feature during the customer-agent interaction. The classifier model 125 then outputs the predicted value 131 for further utilization by the system executing the KPI prediction process or by another system or application, such as an agent coaching application or a performance ranking application.

For example, in some aspects, at step 132, the predicted value is compared to the target value for the KPI metric to determine whether the value predicted for the KPI metric meets the target value. If it is determined that the value predicted for the KPI metric meets or exceeds the target value, “Yes” at step 132, then the process continues to step 134.

At step 134, when the value predicated for the KPI metric by the classifier model 125 does not meet or exceed the target value, features with a potential for improvement are determined. Before determinations at step 134 and step 138 are carried out, step 136 provides one or more sets of predefined features that are determined to be controllable by an agent, such as a human agent, a chatbot, or both, when engaged in a customer-agent interaction. For example, some features that are under the control of a human agent include, but are not limited to, the time an agent spends talking during a call with a customer, the number of interruptions by the agent in the call, a call duration, a number of holds in the call, the time of mutual silence in the call, the screen module used in the call, KM searches conducted by the agent, CRM access patterns by the agent, length of employment, position or title information, and the like. The aforementioned features may also apply to a chatbot. However, some of the aforementioned features would not apply to a chatbot, such as the screen module used in the call, length of employment, and position or title information. Additionally, there may be some features that apply to a chatbot that may not apply to a human agent, for example, a quantity of out-of-vocabulary inputs or a per response feedback score, such as a thumbs-up or thumbs-down, or ranking out of 5 points. While many features may apply to both human agents and chatbot, how a feature of the one or more sets of predefined features is quantified or defined may need to be refined. For example, the feature for time a human agent spent talking on call may be determined to correspond to the amount of time a chatbot spent generating a response to an input.

At step 136, the KPI prediction process may determine a type of flag to set for each of the one or more features in the set of predefined features. The type of flag may indicate whether the feature is under the control of a human agent, a chatbot, or both. In some instances, the KPI prediction process, at step 136, may indicate with a flag as to which of the features from the set of predefined features is applicable to the customer-agent interaction being analyzed based on whether the agent is a human agent or a chatbot.

Accordingly, the determinations at step 134 are based only on features that are controllable by the agent. Without limiting the determinations at step 134 and step 138 to features that are controllable by the agent, suggestions for potential improvements to increase the KPI metric may be ones that the client cannot implement as they are outside of their control, such as the time a customer spends talking during the call, time between an agent's hire date and the call date.

At step 134, for example, the system is configured to determine, from the plurality of features that the classifier model 125 identifies and measures from the customer-agent interaction data, at least one feature with a potential for improvement, such that when the at least one feature is improved, the value predicted for the KPI metric increases. Moreover, still at step 134, in some aspects, the system is configured to determine, from the plurality of features that the classifier model 125 identifies and measures from the customer-agent interaction data, a feature with a highest improvement potential whereby improving the feature increases the value predicted for the KPI metric. For example, the model may identify the presence of features such as interruptions by the agent, mutual silence in a call, call duration, agent talk time and customer talk time within the customer-agent interaction data. The model may further quantify (e.g., measure) each of the features and determine a measured value for each which is also referred to herein as a feature value. Based on each of the measure values, the system may determine which of the features has room for improvement. This determination may take into account positively viewed feature values for the corresponding feature and compare them to the measured value to determine if there is room for improvement. For example, a positively viewed number of interruptions may be zero and a positively viewed percentage of agent talk time may be 50% or less. The difference between the measured values and the positively viewed feature values can provide an indication as to whether there is potential for improvement with respect to the feature. It is understood that this merely one example of determining whether a feature has a potential for improvement.

In similar aspects, a ranking of features may be determined. For example, the features may be ranked in a ranked list based on a margin available to improve that feature. The features may be ranked in a second ranked list based on the amount of change that an improvement to each feature would have on the KPI metric.

At step 138, an amount of change for each feature is determined. The amount of change indicates the amount each feature needs to change in order for the KPI metric to meet or exceed the target value. There may be multiple combinations of features and respective improvement amounts that will result in the KPI metric meeting or exceeding the target value. Accordingly, in some aspects a matrix of features and respective amounts of change may be generated and/or output. Based on the determinations made at step 134 and step 138, a client receives actionable information that may lead to improvements in their KPI metric. For example, in some aspects, the apparatus performing the KPI prediction process is configured to determine one or more features with a potential for improvement such that when the one or more features are improved, the value predicted for the KPI metric increases. The apparatus may be further configured to determine an amount that each of the one or more features need to improve such that the value predicted for the KPI metric meets the target value and output a report indicating the value predicted for the KPI metric, the one or more features with the potential to improve, and the amount that each of the one or more features need to improve.

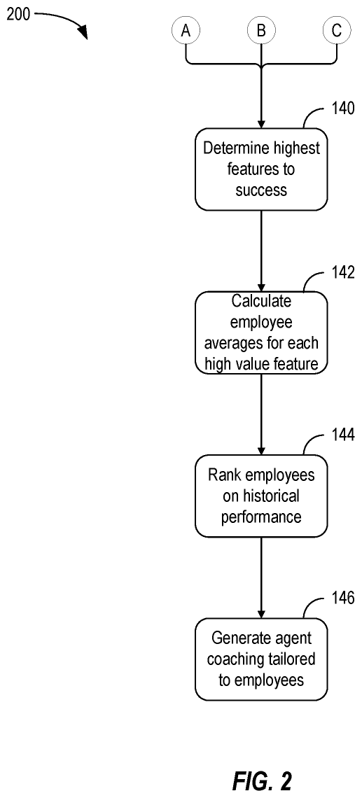

If it is determined that the value predicted for the KPI metric does not meet the target value, “No” at step 132, then the process continues to step 140, depicted and described with reference to FIG. 2.

FIG. 2 depicts an illustrative block diagram 200 that is an extension of the illustrative block diagram 100 of the KPI prediction process shown in FIG. 1. More specifically, the illustrative block diagram 200 depicts aspects of the KPI improvement process. The following process provides steps for determining which features drive the highest success in achieving or exceeding the target value for the KPI metric (step 140), calculating agents' performance average for each feature that drives high success (step 142), ranking the agents based on historical performance (step 144), and generating tailored coaching for the agents (step 146).

Inputs to the KPI improvement process depicted in illustrative block diagram 200 include the determination as to whether the value predicted for the KPI metric meets the target value from step 132, a set of predefined features controllable by the agent from step 136, and the amount of change each feature needs to change to meet or exceed the target value for the KPI metric from step 138.

At step 140, the features that drive the highest success or positive increase in the KPI metric are determined from the features that are controllable by the agent. For example, the features are ranked from the most positive impacting feature to the least positive impacting feature. The most positive impacting feature is a feature where the smallest amount of change in feature value (e.g., the measured value of the feature) results in the largest change in value for the KPI metric. For example, if reducing the amount of interruptions by an agent in a call by 10% results in a 50% increase in the KPI metric whereas reducing the amount of mutual silence in a call by 20% results in a 50% increase in the KPI, then the feature of the amount of interruptions by the agent in the call would be the most positive impacting feature. In other words, a smaller improvement would be needed to the feature of the amount of interruptions by the agent than the amount of mutual silence in the call to generate an equal improvement in the KPI metric.

At step 142, each agents' 122 average performance with respect to the features (e.g., the top 5%, top 10%, top 50% of the features) is calculated. In some aspects, the average performance of each agent is calculated for some or all of the features. The features the agent is evaluated on are at least the features corresponding to the set of predefined features controllable by the agent. Additionally, at step 144, the agents are ranked based on their calculated averages and/or their historical performance.

At step 146, coaching specific to improving features of an agent's interactions with a customer is generated, such as training or refreshers that are relevant to the agents. Furthermore, tailored coaching provides a technical benefit of providing efficient and effective training that directly relates to improvement potential for the agent.

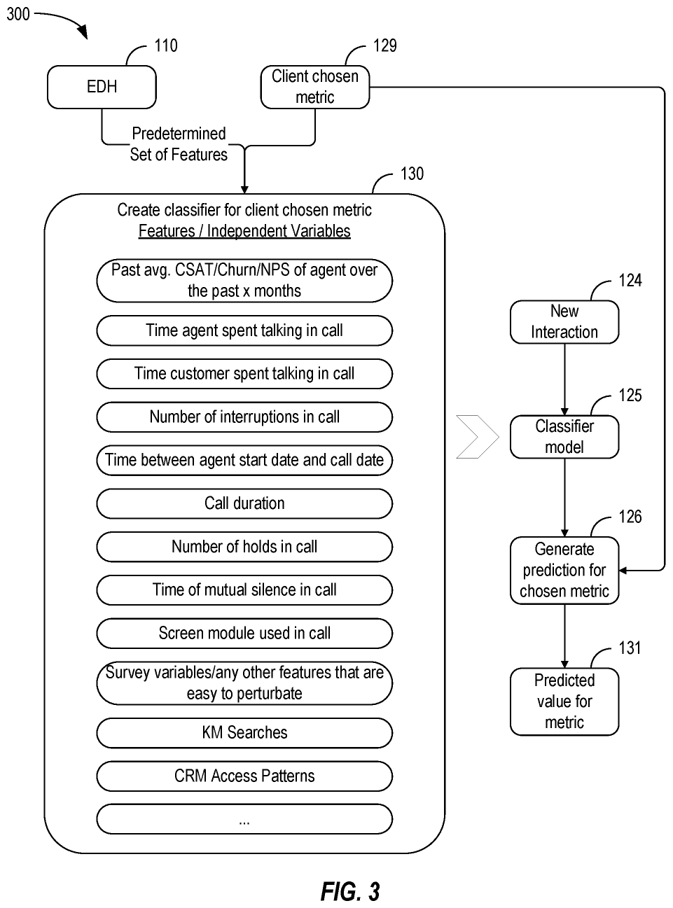

Turning to FIG. 3, an illustrative block diagram 300 for creating a classifier model for the KPI prediction process is depicted. The block diagram 300 corresponds to the steps depicted in the block diagram 100 of FIG. 1 however, some steps are depicted in additional detail. For concise explanation, steps previously described are not repeated here. At step 130, the classifier model corresponding to the client's selected KPI metric is created (or selected, if already created). Here, step 130 is expanded to illustrate example features utilized for training the classifier model and features that are considered by the trained version of the model. For example, features include past average CSAT, Churn, NPS of an agent over a past period of time, the time an agent spends talking during a call with a customer, the time a customer spends talking during the call, the number of interruptions in the call, time between an agent's hire date and the call date, a call duration, a number of holds in the call, the time of mutual silence in the call, the screen module used in the call, KM searches conducted by the agent, CRM access patterns by the agent, survey variables and/or any other features that can be ascertained from the customer-agent interaction.

The features can be a mix of agent behaviors such as number of holds or environmental features such as the screen module used to make the call. Once the classifier model 125 is trained, every time a new interaction occurs at step 124, the interaction data can be fed to the classifier model 125 to generate (e.g., at step 126) the predicted value 131 for the target value for the KPI metric. As discussed with reference to FIG. 1, if the classifier prediction is below a target value, the process proceeds with determining which features need to be improved (e.g., at step 134) and by how much (e.g., at step 138) so target value for the KPI metric can be meet.

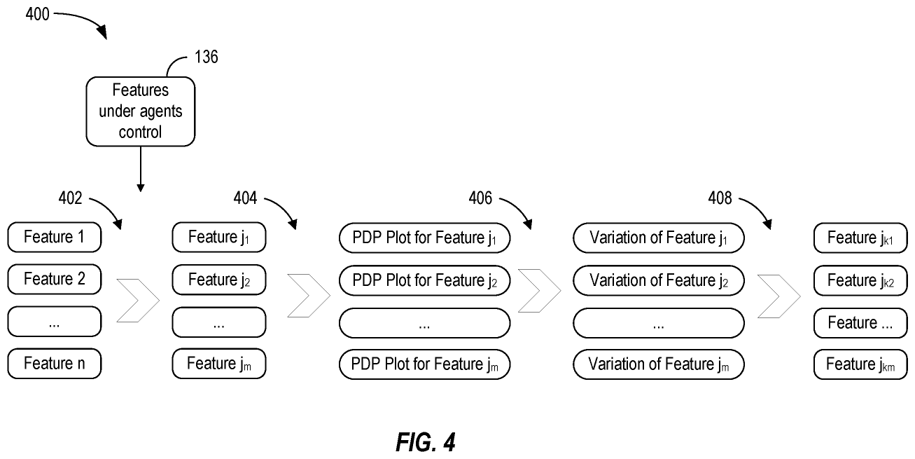

FIG. 4 depicts an illustrative diagram 400 of a process for determining features that, when improved, increase the value predicted for the KPI. For example, the process depicted in detail in FIG. 4 may be implemented with step 134 depicted and described with reference to FIG. 1.

Describing FIG. 4 left to right, there are n number of features/variables that can be defined in customer-agent interaction data. However, the feature space needs to be narrowed to those that are controllable by the contact center agent as offering suggestions to improve features outside of their control is not actionable. Accordingly, step 402 includes filtering out the features from the initial plurality of features (e.g., Feature 1, Feature 2, . . . , Feature n) that the contact center agent has no control over based on a set of predefined features determined to be in control of the agent. A filtered set of features (Feature j₁, Feature j₂, . . . , Feature jₘ) includes a subset of the initial plurality of n features.

Next at step 404, partial dependence plots (PDP) for each of the filtered set of features are created. The partial dependence plots define a relationship between a change to a feature value and a probability of changing the KPI metric. For example, the x-axis of the PDP is changing the feature value. The y-axis of the PDP shows how much the prediction probability for the class (target KPI metric) changes. Therefore, the system can directly determine from the range of y in the PDPs the variations in predictive probability by changing the feature value.

Step 406 includes utilizing the PDPs to determine variations in the predictive probability of the feature value. That is, step 406 determines the amount that a feature has to change so that the KPI metric meets the target value. It is noted that the amount a feature has to change may depend on changes made by other features. Accordingly, in some aspects, the process at step 406 considers feature value changes of other features in combination with an amount of change to feature value of a present feature. In other words, other features may bring the KPI metric close to the target value thus leaving a smaller gap that needs to be closed by a present feature (e.g., a secondary feature).

At step 408, features are sorted (high to low) based on the size of the potential improvement by ranking the variations. The larger the variation, the more room for improvement a feature is determined to be capable of providing.

### Example Method for Providing a Predicted Value for a KPI and Identifying Feature to Improve the Predicted Value for KPI

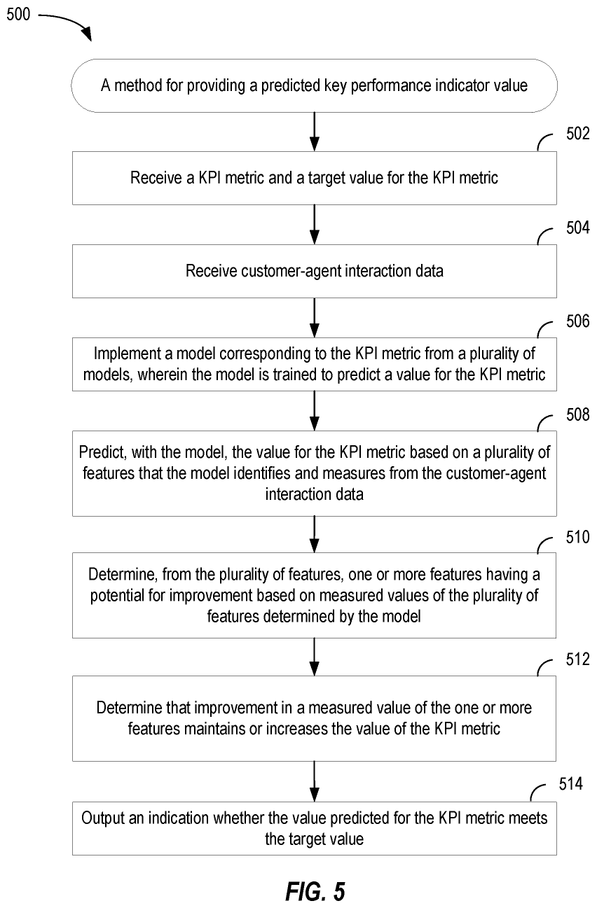

FIG. 5 depicts an example method for predicting a KPI value and identifying features for improving the KPI value.

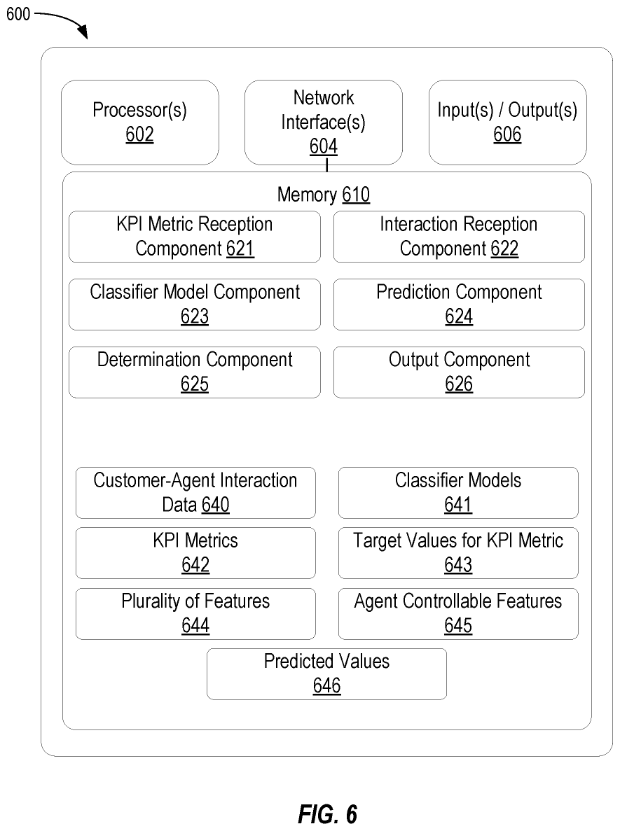

In this example, method 500 begins at step 502 receiving a KPI metric and a target value for the KPI metric. For example, step 502 may be performed by the apparatus 600 as described herein with reference to FIG. 6 that is configured to perform at least the process corresponding to step 128 as described above with reference to FIG. 1.

Method 500 proceeds to step 504 with receiving customer-agent interaction data. For example, step 504 may be performed by the apparatus 600 as described herein with reference to FIG. 6 that is configured to perform the process corresponding to step 124 as described above with reference to FIG. 1.

Method 500 proceeds to 506 with implementing a model corresponding to the KPI metric from a plurality of models, wherein the model is trained to predict a value for the KPI metric. For example, step 506 may be performed by the apparatus 600 as described herein with reference to FIG. 6 that is configured to perform the process corresponding to step 130 as described above with reference to FIG. 1.

Method 500 proceeds to 508 with predicting, with the classifier model, the value for the KPI metric based on a plurality of features that the classifier model identifies and measures from the customer-agent interaction data. For example, step 508 may be performed by the apparatus 600 as described herein with reference to FIG. 6 that is configured to perform the process corresponding to step 126 as described above with reference to FIG. 1.

Method 500 proceeds to 510 with determining, from the plurality of features, one or more features having a potential for improvement based on measured values of the plurality of features determined by the model. For example, step 510 may be performed by the apparatus 600 as described herein with reference to FIG. 6 that is configured to perform the processes corresponding to steps 134 and 138 as described above with reference to FIG. 1.

Method 500 proceeds to 512 with determining that improvement in a measured value of the one or more features maintains or increases the value of the KPI metric. For example, step 512 may be performed by the apparatus 600 as described herein with reference to FIG. 6 that is configured to perform the processes corresponding to steps 134 and 138 as described above with reference to FIG. 1.

Method 500 proceeds to 514 with outputting an indication whether the value predicted for the KPI metric meets the target value. For example, step 514 may be performed by the apparatus 600 as described herein with reference to FIG. 6 that is configured to perform the process corresponding to step 126 as described above with reference to FIG. 1.

In some aspects, the method 500 further includes determining that the value predicted for the KPI metric by the classifier model does not meet the target value and when the value predicated for the KPI metric by the classifier model does not meet or exceed the target value, determining, from the plurality of features that the classifier model identifies and measures from the customer-agent interaction data, at least one feature with a potential for improvement such that when the at least one feature is improved, the value predicted for the KPI metric increases.

In some aspects, the method 500 further includes determining that the value predicted for the KPI metric by the model does not meet the target value, and determining, from the second set of features, a second subset of features that when improved causes the value predicted for the KPI metric to meet or exceed the target value for the KPI metric.

In some aspects, the method 500 further includes outputting a report indicating the second subset of features that when improved causes the value predicted for the KPI metric to meet or exceed the target value for the KPI metric.

In some aspects, the method 500 further includes determining an amount of change for each feature of the second subset of features to cause the value predicted for the KPI metric to meet or exceed the target value for the KPI metric, and outputting a report indicating the second subset of features and the amount of change for each feature of the second subset of features.

In some aspects, the method 500 further includes ranking the second subset of features into a ranked list based on the amount of change for each feature, wherein the report provides an indication of the second subset of features in the ranked list.

In some aspects, the method 500 further includes determining a feature from the second subset of features having a highest positive impact to the value of the KPI metric with a lowest amount of change to the measured value, and outputting an indication of the feature that has the highest positive impact to the value of the KPI metric with the lowest amount of change to the measured value.

In some aspects, the method 500 further includes determining the second subset of features that when improved causes the value predicted for the KPI metric to meet or exceed the target value for the KPI metric is based on partial dependence plots for each feature of the second subset of features, and the partial dependence plots define a relationship between a change to measured value and a probability of changing the KPI metric.

The method 500 provides technical solutions for predicting a value for a KPI metric by reducing or eliminating the need for post interaction surveys. That is, the technical solution provides the ability to analyze customer-agent interaction data to predict a KPI metric for the interaction without the need for customer feedback on the interaction. Furthermore, the method 500 provides indications of features that can deliver improvements to the value for the KPI metric which provide the technical benefit of process that can automatically assist with maintaining or improving KPI metrics, again with a reduction in or elimination of post interaction surveys.

Note that FIG. 5 is just one example of a method, and other methods including fewer, additional, or alternative steps are possible consistent with this disclosure.

### Example Apparatus for Providing a Predicted Value for a KPI

FIG. 6 depicts an example apparatus 600 configured to perform the methods described herein.

Apparatus 600 includes one or more processors 602. Generally, processor(s) 602 may be configured to execute computer-executable instructions (e.g., software code) to perform various functions, as described herein.

Apparatus 600 further includes a network interface(s) 604, which generally provides data access to any sort of data network, including personal area networks (PANs), local area networks (LANs), wide area networks (WANs), the Internet, and the like.

Apparatus 600 further includes input(s) and output(s) 606, which generally provide means for providing data to and from apparatus 600, such as via connection to computing device peripherals, including user interface peripherals.

Apparatus 600 further includes a memory 610 configured to store various types of components and data.

In this example, memory 610 includes a KPI metric reception component 621, an interaction reception component 622, a classifier model component 623, a prediction component 624, a determination component 625 and an output component 626.

The KPI metric reception component 621 is configured to perform step 128 of the KPI prediction process depicted and described with reference to FIG. 1 and step 502 of the method 500 depicted and described with reference to FIG. 5.

The interaction reception component 622 is configured to perform step 124 of the KPI prediction process depicted and described with reference to FIG. 1 and step 504 of the method 500 depicted and described with reference to FIG. 5.

The classifier model component 623 is configured to perform step 130 of the KPI prediction process depicted and described with reference to FIG. 1 and step 506 of the method 500 depicted and described with reference to FIG. 5.

The prediction component 624 is configured to perform step 126 of the KPI prediction process depicted and described with reference to FIG. 1 and step 508 of the method 500 depicted and described with reference to FIG. 5.

The determination component 625 is configured to perform steps 134 and 138 of the KPI prediction process depicted and described with reference to FIG. 1 and steps 510 and 512 of the method 500 depicted and described with reference to FIG. 5.

The output component 626 is configured to perform at least step 514 of the method 500 depicted and described with reference to FIG. 5.

In this example, memory 610 also includes customer-agent interaction data 640, classifier models 641, KPI metrics 642, target value for KPI metric 643, plurality of features 644, agent controllable features 645, and predicted values 646 as described herein.

Apparatus 600 may be implemented in various ways. For example, apparatus 600 may be implemented within on-site, remote, or cloud-based processing equipment.

Apparatus 600 is just one example, and other configurations are possible. For example, in alternative embodiments, aspects described with respect to apparatus 600 may be omitted, added, or substituted for alternative aspects.

### Example Clauses

Implementation examples are described in the following numbered clauses:
Clause 1: A method for providing a predicted key performance indicator (KPI) value, comprising: receiving a KPI metric and a target value for the KPI metric; receiving customer-agent interaction data; implementing a model corresponding to the KPI metric from a plurality of models, wherein the model is trained to predict a value for the KPI metric; predicting, with the model, the value for the KPI metric based on a plurality of features that the model identifies and measures from the customer-agent interaction data; determining, from the plurality of features, one or more features having a potential for improvement based on measured values of the plurality of features determined by the model; determining that improvement in a measured value of the one or more features maintains or increases the value of the KPI metric; and outputting a first indication of whether the value predicted for the KPI metric meets the target value and a second indication of the one or more features that maintains or increases the value of the KPI metric when the one or more features are improved.
Clause 2: The method of Clause 1, further comprising: identifying a first subset of features from the one or more features that are not controllable by an agent when engaged in a customer-agent interaction; and generating a second set of features by filtering out the first subset of features from the one or more features.
Clause 3: The method of Clause 2, further comprising: determining that the value predicted for the KPI metric by the model does not meet the target value; and determining, from the second set of features, a second subset of features that when improved causes the value predicted for the KPI metric to meet or exceed the target value for the KPI metric.
Clause 4: The method of Clause 3, further comprising outputting a report indicating the second subset of features that when improved causes the value predicted for the KPI metric to meet or exceed the target value for the KPI metric.
Clause 5: The method of Clause 3, further comprising: determining an amount of change for each feature of the second subset of features to cause the value predicted for the KPI metric to meet or exceed the target value for the KPI metric; and outputting a report indicating the second subset of features and the amount of change for each feature of the second subset of features.

Clause 6: The method of Clause 5, further comprising ranking the second subset of features into a ranked list based on the amount of change for each feature, wherein the report provides an indication of the second subset of features in the ranked list.

Clause 7: The method of any one of Clauses 5-6, further comprising: determining a feature from the second subset of features having a highest positive impact to the value of the KPI metric with a lowest amount of change to the measured value; and outputting an indication of the feature that has the highest positive impact to the value of the KPI metric with the lowest amount of change to the measured value.

Clause 8: The method of any one of Clauses 3-7, wherein: determining the second subset of features that when improved causes the value predicted for the KPI metric to meet or exceed the target value for the KPI metric is based on partial dependence plots for each feature of the second subset of features, and the partial dependence plots define a relationship between a change to the measured value and a probability of changing the KPI metric.

Clause 9: The method of any one of Clauses 1-8, wherein the model is a classifier model selected from a plurality of trained classifier models based on the KPI metric.

Clause 10: A processing system, comprising: a memory comprising computer-executable instructions; and a processor configured to execute the computer-executable instructions and cause the processing system to perform a method in accordance with any one of Clauses 1-9.

Clause 11: A processing system, comprising means for performing a method in accordance with any one of Clauses 1-9.

Clause 12: A non-transitory computer-readable medium comprising computer-executable instructions that, when executed by a processor of a processing system, cause the processing system to perform a method in accordance with any one of Clauses 1-9.

Clause 13: A computer program product embodied on a computer-readable storage medium comprising code for performing a method in accordance with any one of Clauses 1-9.

### Additional Considerations

The terminology used herein is for the purpose of describing particular aspects only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

It will be apparent to those skilled in the art that various modifications and variations can be made in the present disclosure without departing from the spirit or scope of the disclosure. Thus, it is intended that the present disclosure cover the modifications and variations of this disclosure provided they come within the scope of the appended claims and their equivalents.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments, but should be defined only in accordance with the following claims and their equivalents.

What is claimed is:

1. A method for providing a predicted key performance indicator (KPI) value, comprising:
receiving a KPI metric and a target value for the KPI metric;
receiving customer-agent interaction data;
implementing a model corresponding to the KPI metric from a plurality of models, wherein the model is trained to predict a value for the KPI metric;
predicting, with the model, the value for the KPI metric based on a plurality of features that the model identifies and measures from the customer-agent interaction data;
determining, from the plurality of features, one or more features having a potential for improvement based on measured values of the plurality of features determined by the model;
determining that improvement in a measured value of the one or more features maintains or increases the value of the KPI metric; and
outputting a first indication of whether the value predicted for the KPI metric meets the target value and a second indication of the one or more features that maintains or increases the value of the KPI metric when the one or more features are improved.

2. The method of claim 1, further comprising:
identifying a first subset of features from the one or more features that are not controllable by an agent when engaged in a customer-agent interaction; and
generating a second set of features by filtering out the first subset of features from the one or more features.

3. The method of claim 2, further comprising:
determining that the value predicted for the KPI metric by the model does not meet the target value; and
determining, from the second set of features, a second subset of features that when improved causes the value predicted for the KPI metric to meet or exceed the target value for the KPI metric.

4. The method of claim 3, further comprising outputting a report indicating the second subset of features that when improved causes the value predicted for the KPI metric to meet or exceed the target value for the KPI metric.

5. The method of claim 3, further comprising:
determining an amount of change for each feature of the second subset of features to cause the value predicted for the KPI metric to meet or exceed the target value for the KPI metric; and
outputting a report indicating the second subset of features and the amount of change for each feature of the second subset of features.

6. The method of claim 5, further comprising ranking the second subset of features into a ranked list based on the amount of change for each feature, wherein the report provides an indication of the second subset of features in the ranked list.

7. The method of claim 5, further comprising:
determining a feature from the second subset of features having a highest positive impact to the value of the KPI metric with a lowest amount of change to the measured value; and
outputting an indication of the feature that has the highest positive impact to the value of the KPI metric with the lowest amount of change to the measured value.

8. The method of claim 3, wherein:
determining the second subset of features that when improved causes the value predicted for the KPI metric to meet or exceed the target value for the KPI metric is based on partial dependence plots for each feature of the second subset of features, and
the partial dependence plots define a relationship between a change to the measured value and a probability of changing the KPI metric.

9. The method of claim 1, wherein the model is a classifier model selected from a plurality of trained classifier models based on the KPI metric.

10. An apparatus configured for providing a predicted key performance indicator (KPI) value, comprising: one or more memories comprising processor-executable instructions; and one or more processors configured to execute the processor-executable instructions and cause the apparatus to:
receive a KPI metric and a target value for the KPI metric;
receive customer-agent interaction data;
implement a model corresponding to the KPI metric from a plurality of models, wherein the model is trained to predict a value for the KPI metric;
predict, with the model, the value for the KPI metric based on a plurality of features that the model identifies and measures from the customer-agent interaction data;
determine, from the plurality of features, one or more features having a potential for improvement based on measured values of the plurality of features determined by the model;
determine that improvement in a measured value of the one or more features maintains or increases the value of the KPI metric; and
output a first indication of whether the value predicted for the KPI metric meets the target value and a second indication of the one or more features that maintains or increases the value of the KPI metric when the one or more features are improved.

11. The apparatus of claim 10, wherein the one or more processors are configured to execute the processor-executable instructions and further cause the apparatus to:
identify a first subset of features from the one or more features that are not controllable by an agent when engaged in a customer-agent interaction; and
generate a second set of features by filtering out the first subset of features from the one or more features.

12. The apparatus of claim 11, wherein the one or more processors are configured to execute the processor-executable instructions and further cause the apparatus to:
determine that the value predicted for the KPI metric by the model does not meet the target value; and
determine, from the second set of features, a second subset of features that when improved causes the value predicted for the KPI metric to meet or exceed the target value for the KPI metric.

13. The apparatus of claim 12, wherein the one or more processors are configured to execute the processor-executable instructions and cause the apparatus to output a report indicating the second subset of features that when improved causes the value predicted for the KPI metric to meet or exceed the target value for the KPI metric.

14. The apparatus of claim 12, wherein the one or more processors are configured to execute the processor-executable instructions and further cause the apparatus to:
determine an amount of change for each feature of the second subset of features to cause the value predicted for the KPI metric to meet or exceed the target value for the KPI metric; and
output a report indicating the second subset of features and the amount of change for each feature of the second subset of features.

15. The apparatus of claim 14, wherein:
the one or more processors are configured to execute the processor-executable instructions and further cause the apparatus to rank the second subset of features into a ranked list based on the amount of change for each feature, and
the report provides an indication of the second subset of features in the ranked list.

16. The apparatus of claim 14, wherein the one or more processors are configured to execute the processor-executable instructions and further cause the apparatus to:
determine a feature from the second subset of features having a highest positive impact to the value of the KPI metric with a lowest amount of change to the measured value; and
output an indication of the feature that has the highest positive impact to the value of the KPI metric with the lowest amount of change to the measured value.

17. The apparatus of claim 12, wherein
determine the second subset of features that when improved causes the value predicted for the KPI metric to meet or exceed the target value for the KPI metric is based on partial dependence plots for each feature of the second subset of features, and
the partial dependence plots define a relationship between a change to the measured value and a probability of changing the KPI metric.

18. The apparatus of claim 10, wherein the model is a classifier model selected from a plurality of trained classifier models based on the KPI metric.

19. A computer program product for providing a predicted key performance indicator (KPI) value, the computer program product comprising instructions, which when executed by a computer, cause the computer to carry out steps comprising:
receiving a KPI metric and a target value for the KPI metric;
receiving customer-agent interaction data;
implementing a model corresponding to the KPI metric from a plurality of models, wherein the model is trained to predict a value for the KPI metric;
predicting, with the model, the value for the KPI metric based on a plurality of features that the model identifies and measures from the customer-agent interaction data;
determining, from the plurality of features, one or more features having a potential for improvement based on measured values of the plurality of features determined by the model;
determining that improvement in a measured value of the one or more features maintains or increases the value of the KPI metric; and
outputting a first indication of whether the value predicted for the KPI metric meets the target value and a second indication of the one or more features that maintains or increases the value of the KPI metric when the one or more features are improved.

20. The computer program product of claim 19, further comprising instructions, which when executed by the computer, cause the computer to carry out the steps of:
identifying a first subset of features from the one or more features that are not controllable by an agent when engaged in a customer-agent interaction; and
generating a second set of features by filtering out the first subset of features from the one or more features.
